(19) United States
(12) Patent Application Publication
(10) Pub. No.: US 2017/0345036 A1
(43) Pub. Date: Nov. 30, 2017

(54) SYSTEM AND METHOD FOR DETERMINING VALUATION OF INTELLECTUAL PROPERTY

(71) Applicant: Songtradr, Inc., Santa Monica, CA (US)

(72) Inventors: Helge Christian Steffen, Los Angeles, CA (US); Paul Lancaster Wiltshire, Pacific Palisades, CA (US)

(21) Appl. No.: 15/608,665

(22) Filed: May 30, 2017

Related U.S. Application Data
(60) Provisional application No. 62/342,236, filed on May 27, 2016.

(51) Int. Cl. G06Q 30/02; G06Q 50/18

(52) U.S. Cl. CPC G06Q 30/0206; G06Q 30/0283; G06Q 50/184

(57) ABSTRACT

An intellectual property valuation system, for use by a seller to generate an automated price for an item of intellectual property, includes a host device, at least one seller-controlled pricing parameter, and a database. The host device includes (i) a seller zone that is selectively accessible by the seller, and (ii) a control system including a processor that generates the seller zone. The at least one seller-controlled pricing parameter is related to the item of intellectual property and is inputted into the seller zone. The control system receives the at least one seller-controlled pricing parameter from the seller zone and generates a seller-controlled pricing matrix for the item of intellectual property that is based at least in part on the at least one seller-controlled pricing parameter. The database is in communication with the control system, and the seller-controlled pricing matrix is transmitted to and stored within the database.

### RELATED APPLICATION

This application claims priority on U.S. Provisional Application Ser. No. 62/342,236, filed on May 27, 2016 and entitled “SYSTEM AND METHOD FOR DETERMINING VALUATION OF INTELLECTUAL PROPERTY”. As far as permitted, the contents of U.S. Provisional Application Ser. No. 62/342,236 are incorporated herein by reference.

### BACKGROUND

The pricing determination of intellectual property rights is very complex and can be based on many factors with thousands of different possibilities. In particular, the pricing of intellectual property rights, such as ownership or licensing of songs or other audio recordings, videos, images, movies, writings, etc., so far is a manual and highly subjective process by the rights holders and/or representatives of the rights holders. In some cases, such property rights might have fixed prices based on fixed factors. However, to allow instant pricing for such intellectual property rights, the seller would have to enter prices for thousands of scenarios which would be extremely time-consuming, if not impossible, especially if the value of the property rights changes over time. Unfortunately, this highly limited, myopic view of pricing determination could very well inhibit sales and/or licensing opportunities. Further, this somewhat archaic pricing scheme may not allow for a flexible price at the point-of-sale.

### SUMMARY

The present invention is directed toward an intellectual property valuation system (and related method) that streamlines the pricing process for a seller or licensor of certain intellectual property. In particular, with this invention, the seller can provide at least one seller-controlled pricing parameter, if not a plurality of seller-controlled pricing parameters, to the intellectual property valuation system for purposes of valuing their intellectual property. In certain embodiments, a control system of the intellectual property valuation system can utilize one or more specially designed algorithms that apply the seller-controlled pricing parameters to the chosen intellectual property to generate specific automated pricing for the intellectual property. The intellectual property valuation system can thus present a buyer with an automatic calculated price for specified intellectual property, based on the at least one seller-controlled pricing parameter, that has been selected by the buyer. Thus, the intellectual property valuation is beneficial to both the seller and the buyer of the intellectual property rights. For the seller, the intellectual property valuation system utilizes a specially designed algorithm to price their intellectual property based on certain seller input, without the seller having to enter numerous different scenarios. For the buyer, he or she no longer has to wait for human interaction during business hours to receive accurate pricing for their intellectual property needs.

As provided herein, the seller-controlled pricing parameters can include, but are not limited to, (i) verticals within which the intellectual property can be used, (ii) territories within which the intellectual property can be used, (iii) term, or length of time, within which the intellectual property can be used by the buyer, (iv) media within which the intellectual property can be used, (v) timing limitation for how much of the intellectual property the buyer can use (i.e. all or a portion thereof), and (vi) pricing strategy (e.g., base price or price range) for determining the automated price at which the intellectual property can be licensed or sold. Additionally, in certain embodiments, the seller-controlled pricing parameters can be further manipulated by a multiplication factor (e.g., 0.1 to 10.0), which can be selectively applied to any or all of the seller-controlled pricing parameters.

More specifically, in various embodiments, the present invention is directed toward an intellectual property valuation system for use by a seller to generate an automated price for licensing or sale of an item of intellectual property, the intellectual property valuation system including a host device, at least one seller-controlled pricing parameter, and a database. The host device includes (i) a seller zone that is selectively accessible by the seller, and (ii) a control system including a processor that generates the seller zone. The at least one seller-controlled pricing parameter is related to the item of intellectual property and is inputted into the seller zone. The control system receives the at least one seller-controlled pricing parameter from the seller zone and generates a seller-controlled pricing matrix for the item of intellectual property that is based at least in part on the at least one seller-controlled pricing parameter. The database is in communication with the control system, and the seller-controlled pricing matrix is transmitted to and stored within the database. The database can be an internal database, i.e. internal to the host device, or an external database, i.e. external to the host device.

In some embodiments, the intellectual property valuation system includes a plurality of seller-controlled pricing parameters that are related to the item of intellectual property and that are inputted into the seller zone. In such embodiments, the control system receives the plurality of seller-controlled pricing parameters from the seller zone and generates the seller-controlled pricing matrix for the item of intellectual property that is based at least in part on each of the plurality of seller-controlled pricing parameters. The seller-controlled pricing matrix can include a separate automated price for the item of intellectual property for each of the plurality of seller-controlled pricing parameters. Additionally, in some such embodiments, the intellectual property valuation system includes a plurality of multipliers, wherein each multiplier is individually applied to one of the plurality of seller-controlled pricing parameters to independently adjust the separate automated price for the item of intellectual property for each of the plurality of seller-controlled pricing parameters.

In certain embodiments, the host device further includes an administration zone that is generated by the control system, the administration zone providing at least one default pricing parameter to the control system. In such embodiments, the at least one seller-controlled pricing parameter is related to the at least one default pricing parameter.

Additionally, in some embodiments, the host device further includes a buyer zone that is generated by the control system, the buyer zone being selectively accessible to a buyer. In certain such embodiments, at least a portion of the seller-controlled pricing matrix is made available to the buyer based on at least one use parameter that is inputted into the buyer zone.

The present invention is further directed toward a method for generating an automated price for licensing or sale of an item of intellectual property, the method including the steps of (A) uploading an item of intellectual property into a seller zone; (B) inputting at least one seller-controlled pricing parameter that is related to the item of intellectual property into the seller zone; (C) receiving the at least one seller-controlled pricing parameter with a control system that generates the seller zone; (D) generating a seller-controlled pricing matrix for the item of intellectual property with the control system, the seller-controlled pricing matrix being based at least in part on the at least one seller-controlled pricing parameter; and (E) transmitting the seller-controlled pricing matrix to a database so that the seller-controlled pricing matrix can be stored within the database.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a simplified schematic illustration of an embodiment of an intellectual property valuation system having features of the present invention, the intellectual property valuation system including a host device having an administration zone, a seller zone and a buyer zone, and at least one seller and at least one buyer that access the host device;

FIG. 2A is a simplified schematic illustration of a portion of the host device that is used to generate a default pricing matrix within the intellectual property valuation system;

FIG. 2B is a simplified schematic illustration of another portion of the host device that is used to generate a seller-controlled pricing matrix within the intellectual property valuation system;

FIG. 3 is an exemplar screen shot illustrating a portion of an embodiment of a pricing matrix that can be generated within the intellectual property valuation system;

FIG. 4A is a simplified flowchart illustrating a representative example of the use of the seller zone of the intellectual property valuation system by the at least one seller;

FIG. 4B is an exemplar screen shot illustrating a portion of the seller zone;

FIG. 4C is an exemplar screen shot illustrating another portion of the seller zone;

FIG. 4D is an exemplar screen shot illustrating still another portion of the seller zone;

FIG. 4E is an exemplar screen shot illustrating yet another portion of the seller zone;

FIG. 4F is an exemplar screen shot illustrating still another portion of the seller zone;

FIG. 4G is an exemplar screen shot illustrating still yet another portion of the seller zone;

FIG. 5A is a simplified flowchart illustrating a representative example of the use of the buyer zone of the intellectual property valuation system by the at least one buyer;

FIG. 5B is an exemplar screen shot illustrating a portion of the buyer zone;

FIG. 5C is an exemplar screen shot illustrating another portion of the buyer zone;

FIG. 5D is an exemplar screen shot illustrating still another portion of the buyer zone;

FIG. 5E is an exemplar screen shot illustrating yet another portion of the buyer zone; and

FIG. 5F is an exemplar screen shot illustrating still yet another portion of the buyer zone.

### DESCRIPTION

Embodiments of the present invention are described herein in the context of a system and method for determining valuation of intellectual property, i.e. for determining specific and variable automated pricing for the licensing or sale of items of intellectual property. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same or similar reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application-related and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

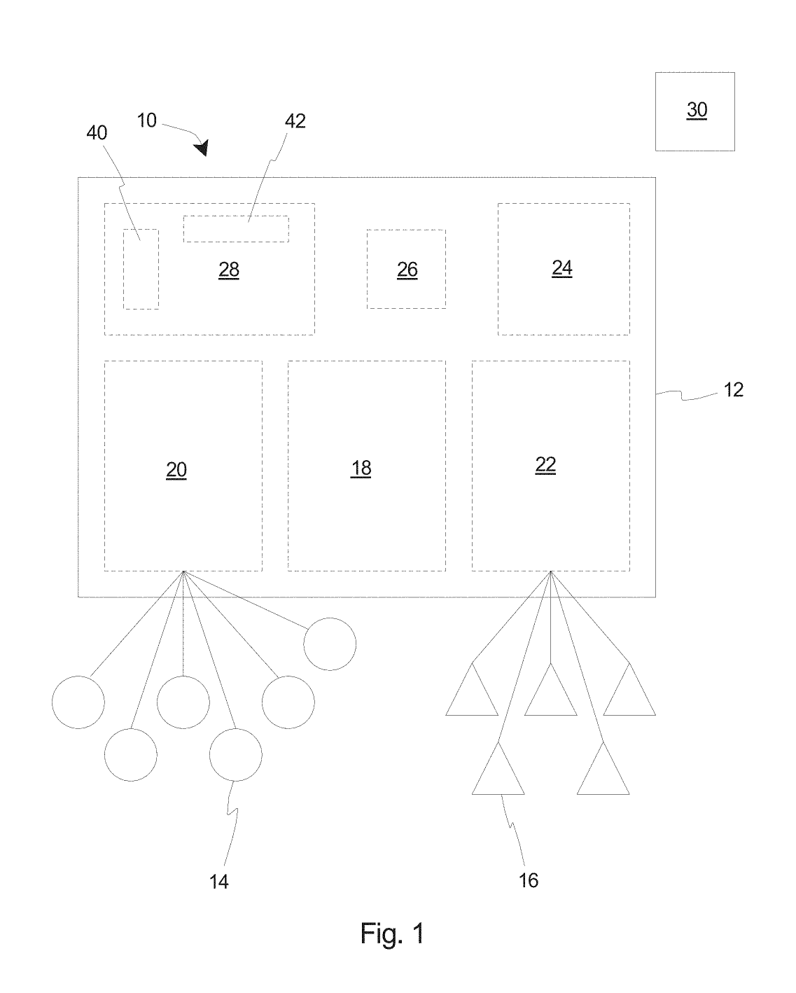

FIG. 1 is a simplified schematic illustration of an embodiment of an intellectual property valuation system 10 (also referred to herein simply as a “valuation system”) having features of the present invention. In various embodiments, the valuation system 10 includes a host device 12, and at least one seller 14 (six are shown in FIG. 1) and at least one buyer 16 (five are shown in FIG. 1) that are able to selectively access the host device 12. As provided herein, the at least one seller 14 is able to upload selected intellectual property into the valuation system 10 for purposes of having the valuation system 10 automatically generate pricing for the licensing or sale of the intellectual property based on certain pricing parameters. Subsequently, the at least one buyer 16 can simply choose from a listing of the available intellectual property based on their specific needs and use parameters that they have provided to the valuation system 10.

The design of the host device 12 and the various components that are included and/or incorporated within the host device 12 can be varied. For example, as shown in FIG. 1, the host device 12 can be a server, a website, an app, or other type of computing device that includes an administration zone 18 (illustrated as a box in phantom), a seller zone 20 (illustrated as a box in phantom), a buyer zone 22 (illustrated as a box in phantom), a memory 24 (illustrated as a box in phantom), at least one internal database 26 (illustrated as a box in phantom), and a control system 28 (illustrated as a box in phantom). Alternatively, the host device 12 can have more components or fewer components than those specifically illustrated in FIG. 1.

Further, in addition to the at least one internal database 26, as shown in FIG. 1, the valuation system 10 can additionally or alternatively include at least one external database 30, i.e. a database that is positioned external to or remotely from the host device 12.

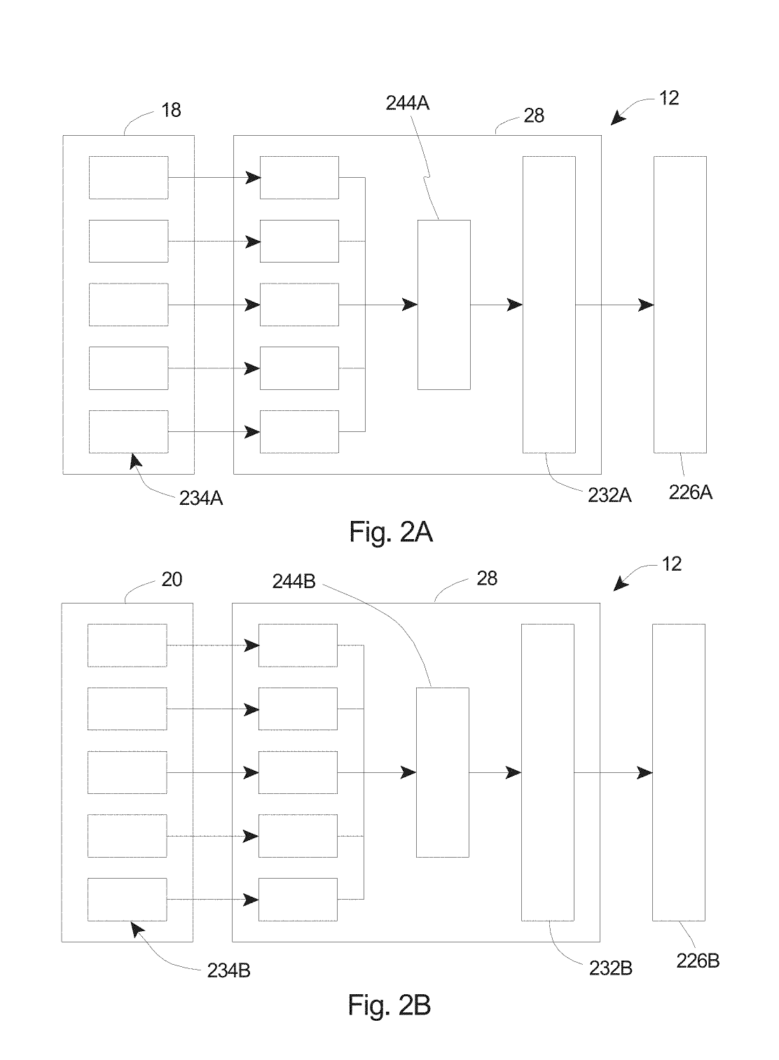

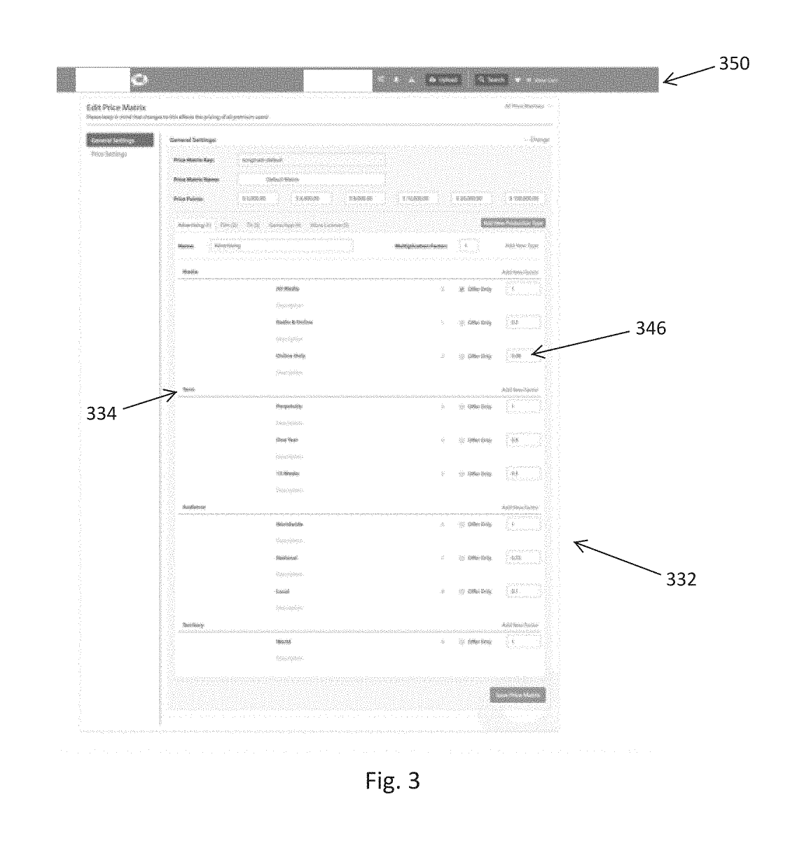

As an overview, in various embodiments, the valuation system 10 is utilized by the at least one seller 14 to generate a pricing matrix 332 (a portion of which is illustrated, for example, in FIG. 3), e.g., a seller-controlled pricing matrix, that provides automated prices for one or more items of intellectual property owned or controlled by the at least one seller 14. More specifically, in such embodiments, the at least one seller 14 can access the seller zone 20 of the host device 12 to input, confirm and/or modify one or more pricing parameters, e.g., one or more default pricing parameters 234A (illustrated in FIG. 2A) that have been provided from the administration zone 18 within the host device 12, to provide one or more seller-controlled pricing parameters 234B (illustrated in FIG. 2B). A description of the item(s) of intellectual property along with the seller-controlled pricing parameters 234B are transmitted and received into the control system 28, which then generates the pricing matrix 332, i.e. the seller-controlled pricing matrix, based upon the seller-controlled pricing parameters 234B and the item(s) of intellectual property to be licensed or sold by the at least one seller 14. In particular, the control system 28 is configured to utilize a uniquely-designed algorithm to generate the seller-controlled pricing matrix 332 based on the inputs of the item(s) of intellectual property and the seller-controlled pricing parameters 234B. The control system 28 then transmits the seller-controlled pricing matrix 332 to one or both of the internal database 26 and the external database 30, which can then be accessed by the at least one seller 16 and the at least one buyer 18, e.g., via the seller zone 20 and the buyer zone 22, respectively.

It is understood that the types of intellectual property being licensed or sold through the valuation system 10 can be varied as desired. For example, in certain non-exclusive embodiments, the valuation system 10 can be utilized for the licensing or sale of a single song or other audio recording, a group (or catalog) of songs or other audio recordings, a single video, a group of videos, a single image, a group of images, a single writing, and/or a group of writings. Accordingly, although the present description and Figures focus primarily on the potential licensing or sale of intellectual property rights to one or more songs, such description is not intended to be limiting in any manner. Stated in another fashion, the valuation system 10, as described in detail herein, can be used for the licensing or sale of any suitable types of intellectual property.

The administration zone 18 is configured to allow certain default settings to be pre-programmed into the pricing matrix 332. In particular, the administration zone 18 can be controlled within the host device 12, e.g., by the control system 28, to provide one or more default pricing parameters 234A that can be utilized for purposes of generating the pricing matrix 332. The number and types of default pricing parameters 234A can be varied as desired. In certain non-exclusive embodiments, the default pricing parameters 234A can include (i) a plurality of verticals (or production types) within which the intellectual property can be used by the at least one buyer 18; (ii) a listing of territories/audiences (e.g., worldwide, or designated continents, countries, states, localities, etc.) within which the intellectual property can be used; (iii) a term (or length of time, e.g., thirteen weeks, one year, perpetuity, etc.) within which the intellectual property can be used by the at least one buyer 18; (iv) the media (e.g., online, radio, television, etc.) within which the at least one buyer can use the intellectual property; (v) a timing limitation for how much of the licensed or sold intellectual property can be used (e.g., all of the intellectual property or a limited portion thereof (thirty seconds, one minute, one chapter, five chapters, etc.); and (vi) price range (or strategy) for the licensing or sale of the intellectual property (e.g., setting a base price anywhere along a continuum or at specific price points from $5,000 to $100,000, in one non-exclusive embodiment). Alternatively, the default pricing parameters 234A can include more or fewer pricing parameters than those specifically listed herein. Additionally, the default pricing parameters 234A (or the seller-controlled pricing parameters 234B) can be defined and/or be labeled in any suitable manner, and the specific labels listed as examples within each pricing parameter are not intended to be limiting in any manner. A more detailed description of certain of the available pricing parameters, i.e. either default pricing parameters 234A or seller-controlled pricing parameters 234B, will be provided herein below.

As utilized herein, a “vertical” includes a brief and general description of the production type and how the intellectual property is intended to be used. For example, a non-exclusive list of potential verticals that can be delineated within the pricing parameters can include, but is not limited to, advertising (all media), advertising (online), advertising (radio and online), app, AR/VR, cable TV, film, film trailer, network TV, TV promo, video game, and video game trailer.

The seller zone 20 of the valuation system 10 can be accessed by the at least one seller 14 for purposes of offering one or more item(s) of intellectual property to be licensed or sold to the consumer public. In particular, as provided herein, the seller 14 can upload any selected items of intellectual property into the valuation system 10, i.e. into the host device 12, for purposes of having the item(s) of intellectual property offered for license or sale to the consumer public. After uploading the item(s) of intellectual property, the seller 14 can then review a default pricing matrix that is generated using the default pricing parameters 234A that have been provided from within the administration zone 18. Subsequently, the seller 14 can then choose to confirm/accept or modify any of the default pricing parameters 234A for purposes of providing seller-controlled pricing parameters 234B. Further, in some embodiments, the seller 14 may have the option to input additional seller-controlled pricing parameters 234B apart from what was initially provided as the default pricing parameters 234A. Additionally or alternatively, in other applications, it is understood that the valuation system 10 can also function as desired without any default pricing parameters 234A being input from the administration zone 18. In such applications, the seller 14 would need to individually input any desired seller-controlled pricing parameters 234B that the seller 14 wants to be considered for purposes of having the valuation system 10 generate pricing for the specific intellectual property.

In various embodiments, the categories of seller-controlled pricing parameters 234B can be substantially identical to the categories of default pricing parameters 234A, as listed above. For example, in such embodiments, the categories of seller-controlled pricing parameters 234B can include (i) verticals, (ii) territories/audiences, (iii) terms, (iv) media, (v) timing limitations, and (vi) price ranges (or strategies). It is understood that pricing parameters that are geared toward having the intellectual property be visible to a larger audience and/or for a longer period of time will typically result in higher licensing or sale prices. For example, pricing parameters that indicate that the intellectual property will be used in films for a worldwide audience will typically result in higher licensing or sales prices than pricing parameters that indicate the intellectual property will be used in local radio advertising.

As utilized herein, a “seller-controlled pricing parameter” is any pricing parameter that is confirmed or modified from the default pricing parameters 234A by the seller 14 or has been inputted independently from the default pricing parameters 234A by or on behalf of the seller 14. It is understood that in certain applications, it is easier to have the administration zone 18 input a full array of default pricing parameters 234A, and the seller 14 need not even make any changes to the default pricing parameters 234A. Regardless of any changes made by the seller 14, any pricing parameters that have been reviewed and confirmed, or modified or input directly by the seller 14 are all considered to be seller-controlled pricing parameters 234B.

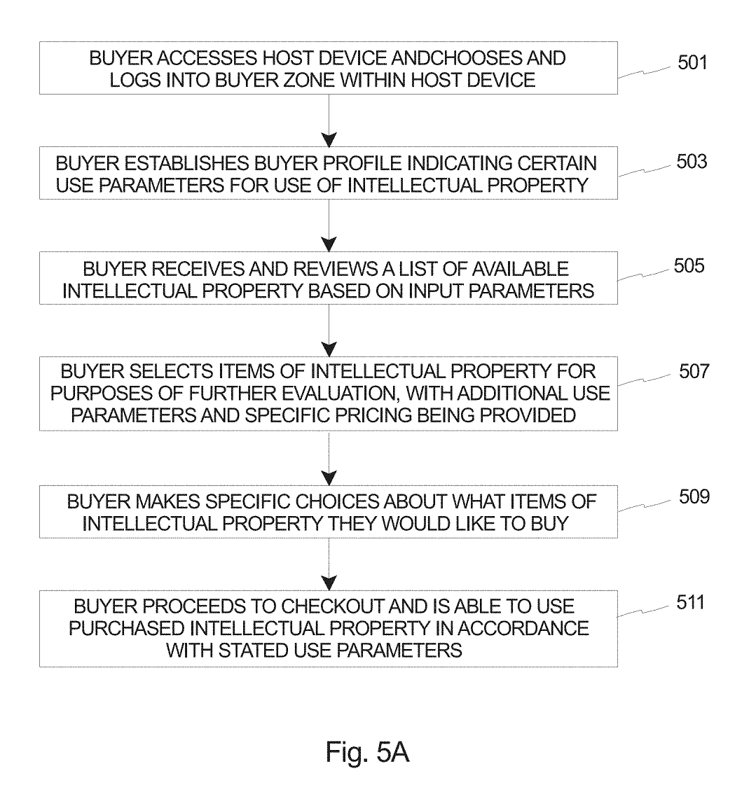

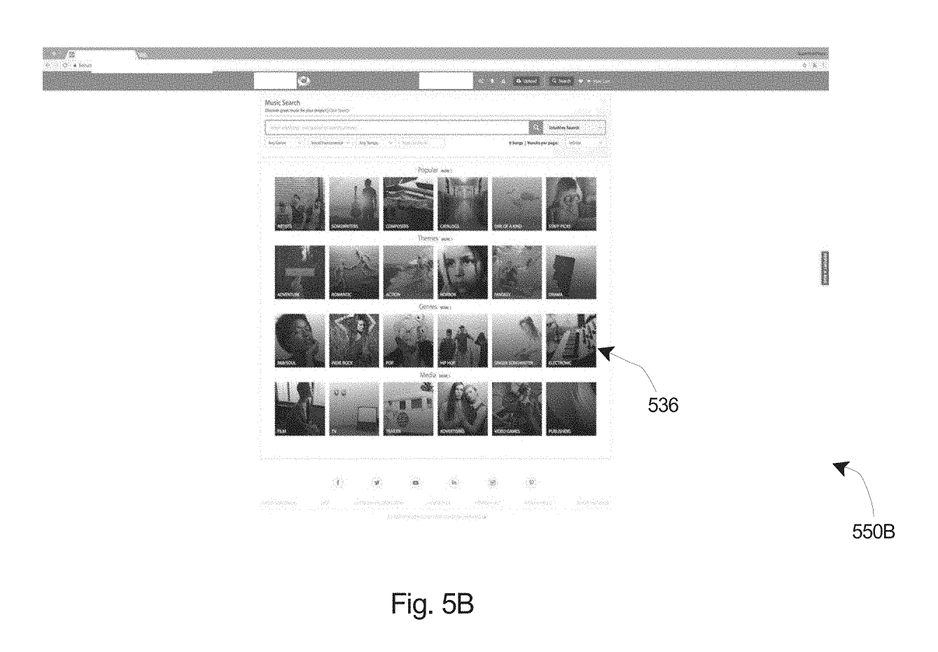

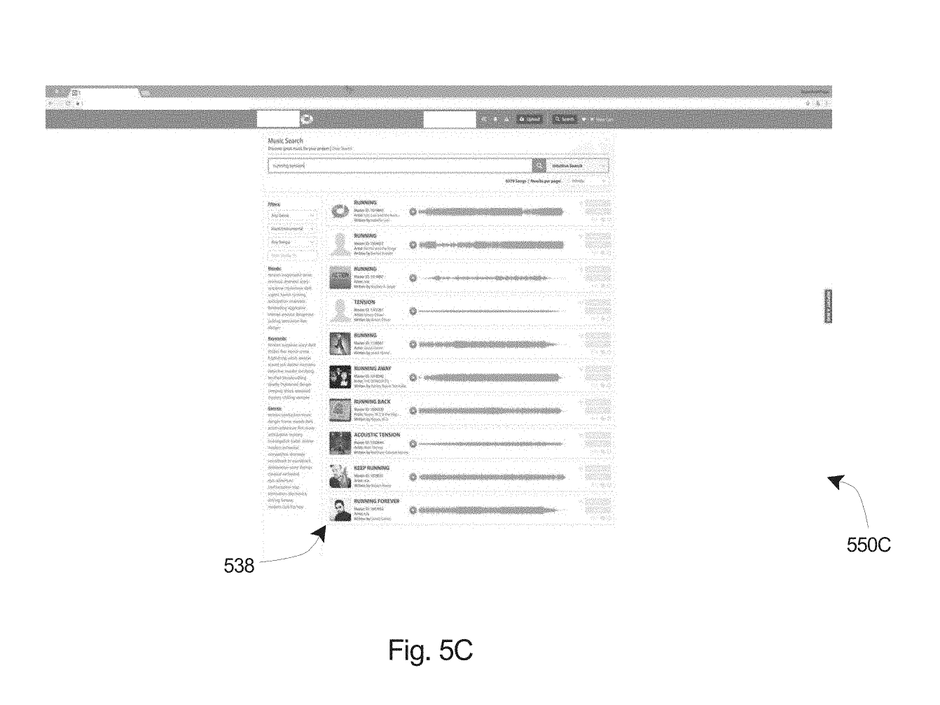

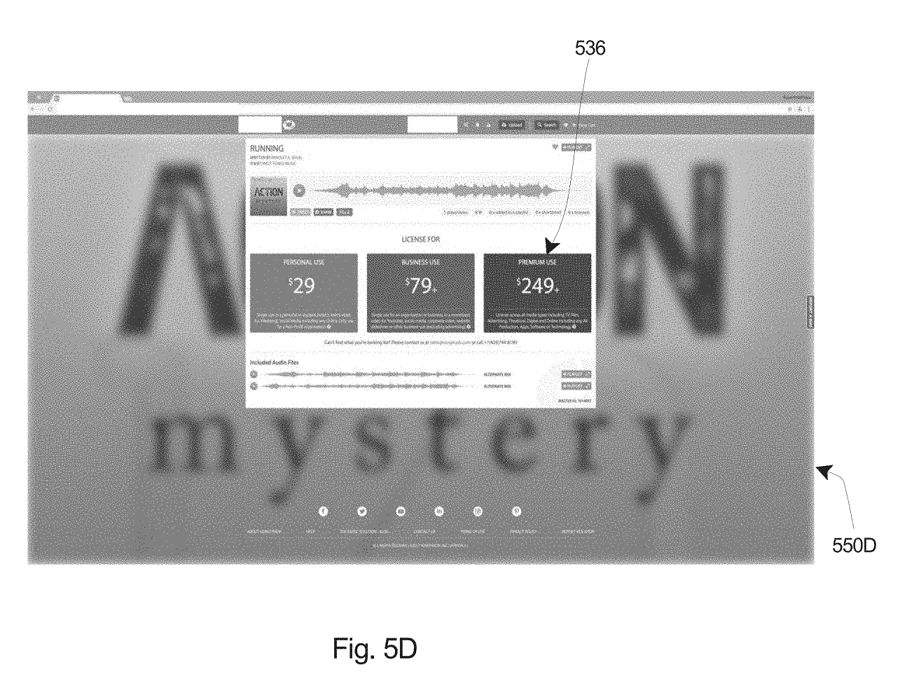

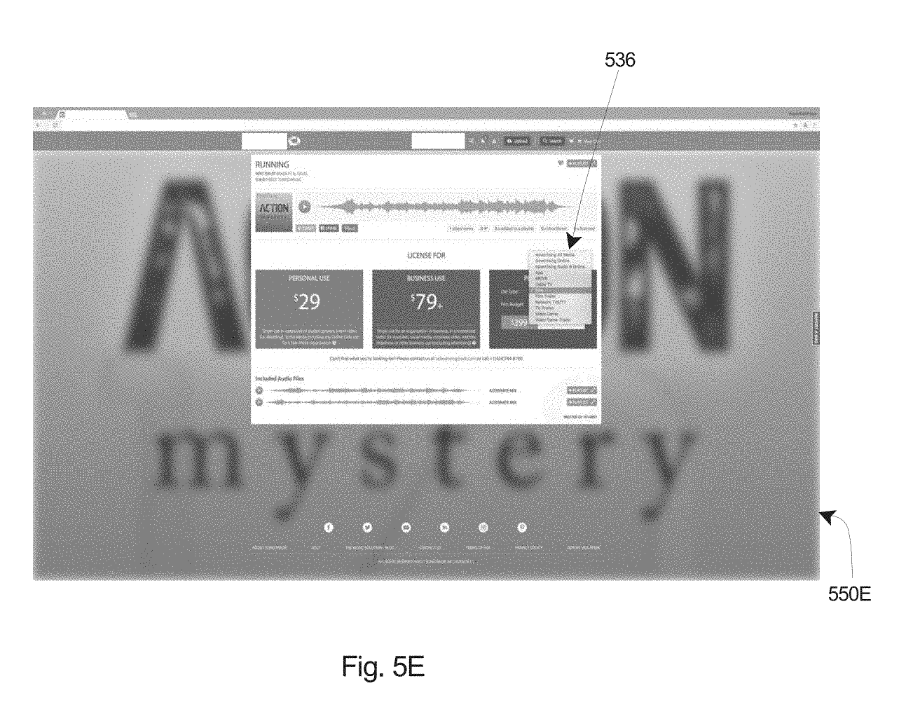

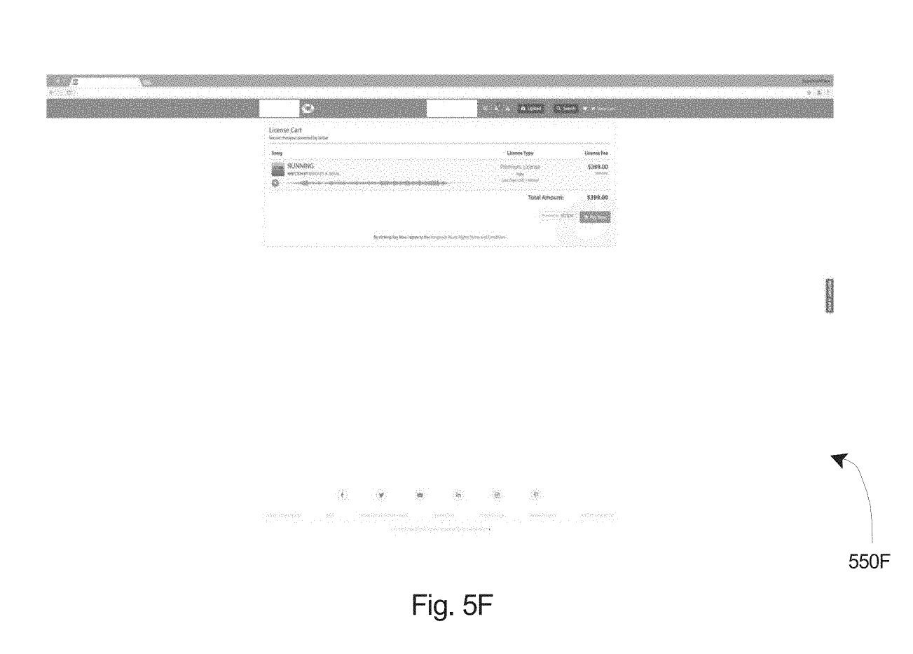

The buyer zone 22 of the valuation system 10 can be accessed by the at least one buyer 16 for purposes of purchasing a license for or purchasing outright any selected item(s) of intellectual property that are offered within the valuation system 10. In particular, as provided in detail herein below, the buyer 16 can input various information and use parameters 536 (as shown, for example, in FIG. 5B) into the host device 12, i.e. via the buyer zone 22, that can be utilized by the control system 28 to generate a list of available items of intellectual property 538 (illustrated in FIG. 5C) in accordance with such use parameters 536. The list of available items of intellectual property 538 is generated from a review of all items of intellectual property stored within the internal database 26 and/or the external database 30, which is then filtered based on the provided use parameters 536. The buyer 16 is then able to select and purchase any such available items of intellectual property 538. As provided herein, in certain embodiments, some use parameters 536 can be inputted by the buyer 16 prior to the host device 12 generating a list of available items of intellectual property 538, and other use parameters 536 can be inputted by the buyer 16 after they have already received the list of available items of intellectual property 538.

The memory 24 can be utilized for temporarily or permanently storing any data and information that is utilized and generated within the valuation system 10. For example, the memory 24 can be utilized to store a full list of available intellectual property, any default pricing parameters 234A, any seller-controlled pricing parameters 234B, any generated pricing matrices, e.g., the pricing matrix 332 illustrated in FIG. 3, any buyer-input use parameters 536, any tailored lists of available items of intellectual property 538 that may be generated based of such buyer-input use parameters 536, and any other information or data used and generated within the valuation system 10.

The internal database 26 can also be utilized for temporary or permanent storage of any data utilized and generated within the valuation system 10, e.g., any and all pricing matrices 332 for the available intellectual property that may be generated within the valuation system 10. As such, the internal database 26 can be incorporated within the memory 24. Thus, as utilized herein, the memory 24 and the internal database 26 can be used or referred to somewhat interchangeably.

The control system 28 can include one or more processors 40 (illustrated in phantom) and one or more circuits 42 (illustrated in phantom) that are configured to control the operation of the valuation system 10. In particular, the control system 28 can be utilized to control (i) operation of and generation of default pricing parameters 234A from the administration zone 18; (ii) access to and transferring of data to and from the seller zone 20; (iii) access to and transferring of data to and from the buyer zone 22; (iv) movement of any data and information into and out of the memory 26 and the databases 26, 30; and (v) processing of any data and information, e.g., information about items of intellectual property and any pricing parameters related thereto, for purposes of generating pricing matrices for the various items of intellectual property that have been uploaded into the valuation system 10.

The external database 30 can be used in conjunction with or in lieu of the internal database 26 for purposes of providing temporary or permanent storage of any data and information utilized and generated within the valuation system 10. As such, it is understood that the valuation system 10 can be configured to include only the internal database 26, only the external database 30, or both the internal database 26 and the external database 30. It is further understood that the valuation system 10 can include any suitable number of internal and external databases.

FIG. 2A is a simplified schematic illustration of a portion of the host device 12 that is used to generate a default pricing matrix 232A (illustrated simply as a box) within the intellectual property valuation system 10. In particular, FIG. 2A illustrates the administration zone 18 being utilized to input or otherwise provide a plurality of pricing parameters 234A, i.e. default pricing parameters, into the control system 28. The control system 28 then applies the default pricing parameters 234A to a selected item of intellectual property 244A for purposes of generating the default pricing matrix 232A. The control system 28 can then transmit the default pricing matrix 232A to a database 226A, which can be either an internal database or an external database.

As provided herein, the valuation system 10 can adequately function with any suitable number of default pricing parameters 234A being input into the control system 28. For example, as shown in FIG. 2A, the administration zone 18 can input five default pricing parameters 234A into the control system 28. Alternatively, the administration zone 18 can input greater than five or less than five default pricing parameters 234A into the control system 28. Additionally, any of the default pricing parameters 234A can be related to any of the other default pricing parameters 234A, or any of the default pricing parameters 234A can be independent from all of the other default pricing parameters 234A. Further, any of the default pricing parameters 234A can have a plurality of subcategories (or sub-parameters) that can further impact the pricing established within the default pricing matrix 232A.

FIG. 2B is a simplified schematic illustration of another portion of the host device 12 that is used to generate a seller-controlled pricing matrix 232B (illustrated simply as a box) within the intellectual property valuation system 10. In particular, FIG. 2B illustrates the seller zone 20 being utilized to input or otherwise provide a plurality of seller-controlled pricing parameters 234B into the control system 28. The control system 28 then applies the seller-controlled pricing parameters 234B to a selected item of intellectual property 244B for purposes of generating the seller-controlled pricing matrix 232B. The control system 28 can then transmit the default pricing matrix 232A to a database 226B, which can be either an internal database or an external database.

Similar to above, the valuation system 10 can adequately function with any suitable number of seller-controlled pricing parameters 234B being input or otherwise provided into the control system 28. For example, as shown in FIG. 2B, the seller 14 (illustrated in FIG. 1) can use the seller zone 20 to input or otherwise provide five seller-controlled pricing parameters 234B into the control system 28. Alternatively, the seller 14 can use the seller zone 20 to input or otherwise provide greater than five or less than five seller-controlled pricing parameters 234B into the control system 28. Additionally, any of the seller-controlled pricing parameters 234B can be related to any of the other seller-controlled pricing parameters 234B, or any of the seller-controlled pricing parameters 234B can be independent from all of the other seller-controlled pricing parameters 234B. Further, any of the seller-controlled pricing parameters 234B can have a plurality of subcategories (or sub-parameters) that can further impact the pricing established within the seller-controlled pricing matrix 232B.

FIG. 3 is an exemplar screen shot 350 illustrating a portion of an embodiment of a pricing matrix 332 that can be generated within the intellectual property valuation system 10 (illustrated in FIG. 1). In particular, the pricing matrix 332 illustrated in FIG. 3 can be a default pricing matrix 232A (illustrated in FIG. 2A) that has been generated through the use of one or more default pricing parameters 234A (illustrated in FIG. 2A), or a seller-controlled pricing matrix 232B (illustrated in FIG. 2B) that has been generated through the use of one or more seller-controlled pricing parameters 234B (illustrated in FIG. 2B).

As illustrated along the left edge of the screen shot 350, the pricing matrix 332 includes a plurality of pricing parameters 334, e.g., Media, Term, Audience and Territory, that can each be defined with a different label. For example, in this non-exclusive embodiment, the “Media” pricing parameter includes a choice between “All Media”, “Radio & Online” and “Online Only”.

Additionally, along the right edge of the screen shot 350, each labeling for each pricing parameter 334 is associated with a particular multiplication factor 346 that impacts the pricing output for the pricing matrix 332. In certain embodiments, the multiplication factor 346 can have a value of between 0.1 and 10.0. More particularly, in some such embodiments, the multiplication factor 346 can have a value of between 0.1 and 1.0. Alternatively, the multiplication factor 346 can have other suitable values.

By way of a specific example, a default or seller-controlled price range or base price for a given item of intellectual property can be set at $9,000. Then, a multiplication factor 346 can be applied for each of the pricing parameters 334, i.e. the default pricing parameters and/or the seller-controlled pricing parameters, that are being utilized or incorporated within the pricing matrix 332. In one non-exclusive application, a “Media” choice of “Radio & Online” can have a multiplication factor of 0.2; a “Term” choice of “Perpetuity” can have a multiplication factor of 1.0; an “Audience” choice of “Worldwide” can have a multiplication factor of 1.0; and a “Territory” choice of “World” can have a multiplication factor of 1.0. Thus, the licensing price for the given item of intellectual property given these pricing parameters 334 would be calculated as: ($9,000)×(0.2)×(1.0)×(1.0)×(1.0)=$1,800.

It is appreciated that a separate licensing (or sale) price will be generated for the given item of intellectual property for each label for each pricing parameter 334 within the pricing matrix 332. Additionally, as described in greater detail herein below, it is further appreciated that the seller 14 (illustrated in FIG. 1) can adjust any and all multiplication factors 346 as desired from an initial default setting. Thus, the multiplication factor 346 for each pricing parameter 334 can also be referred to as a seller-controlled pricing parameter.

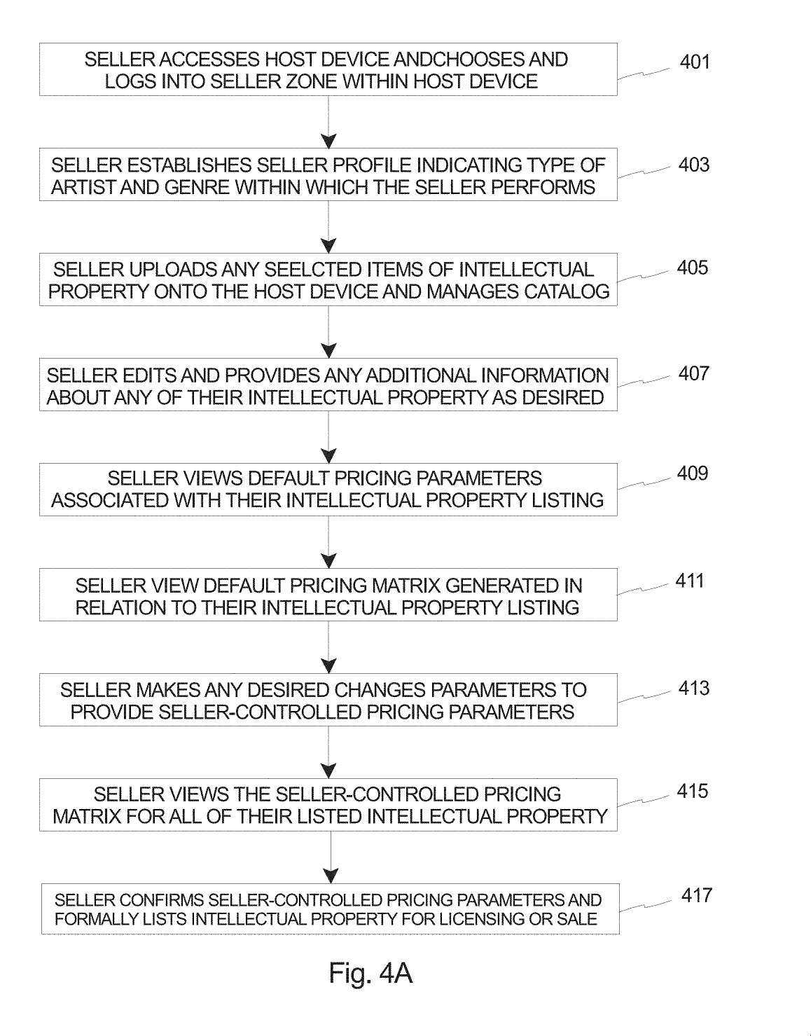

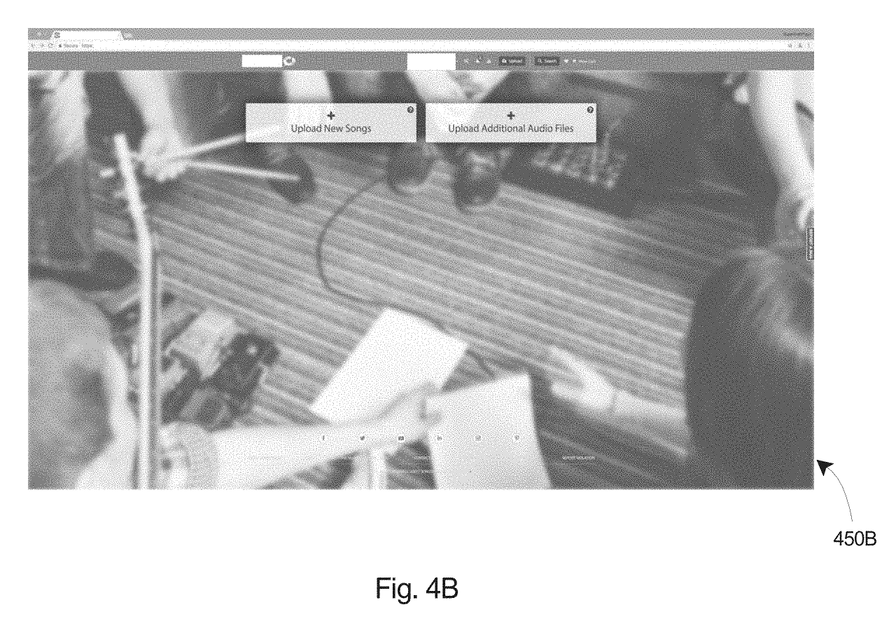

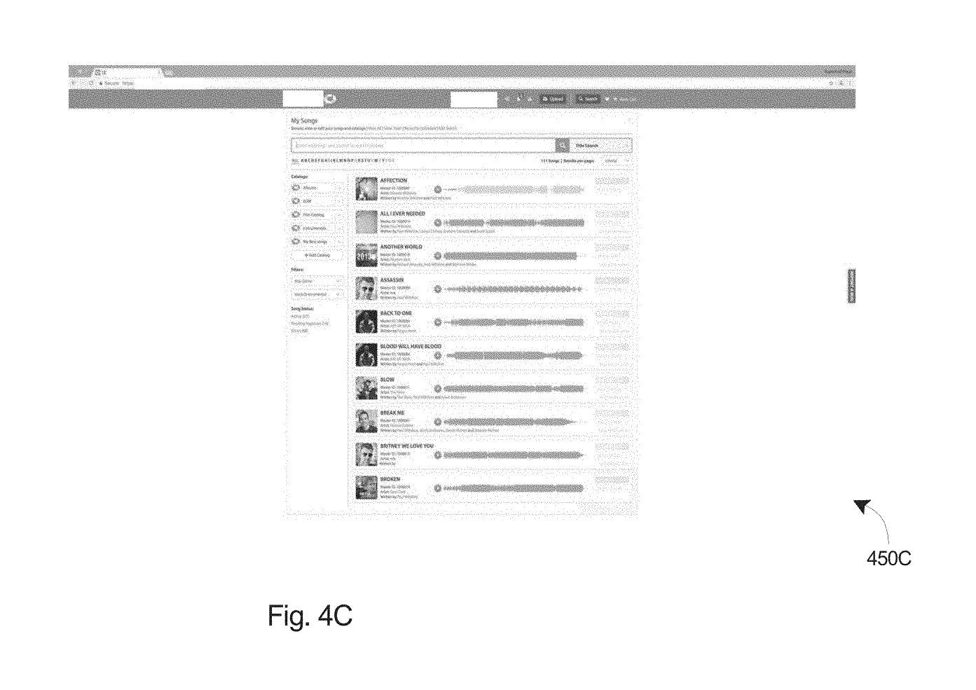

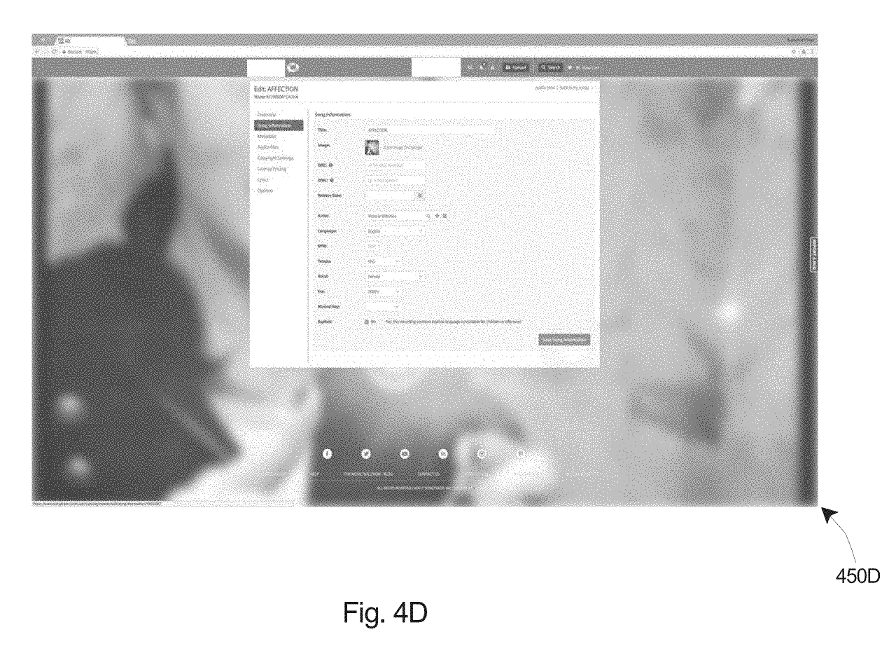

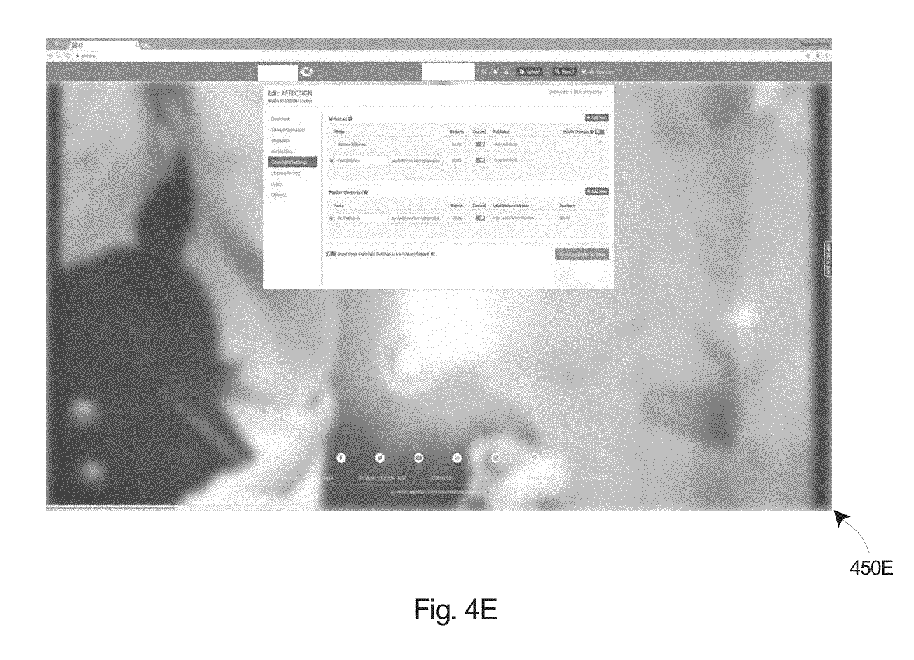

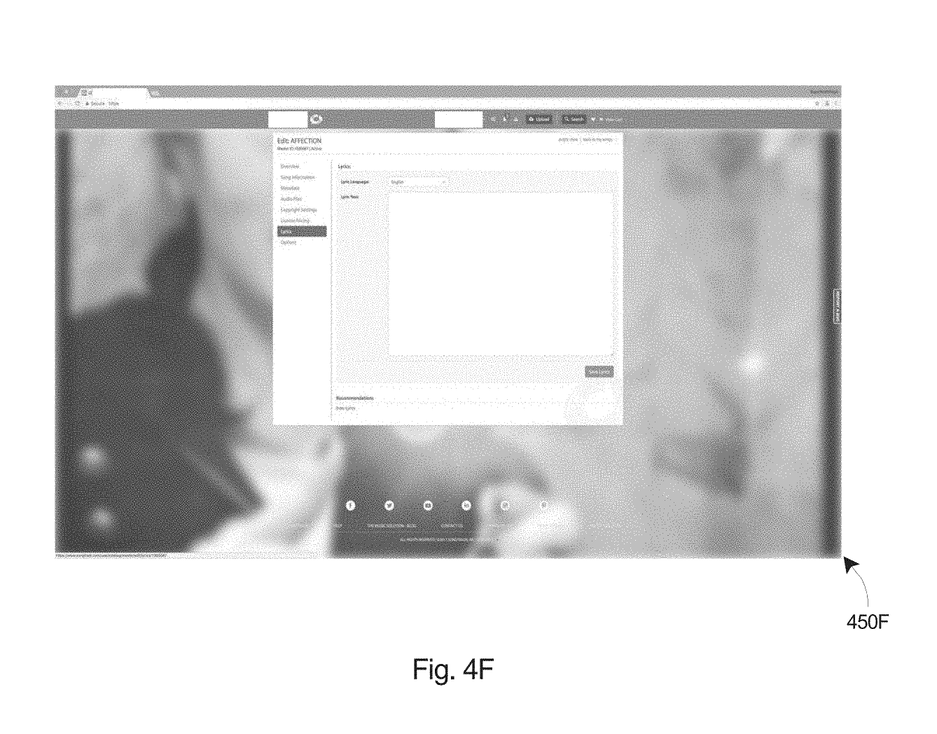

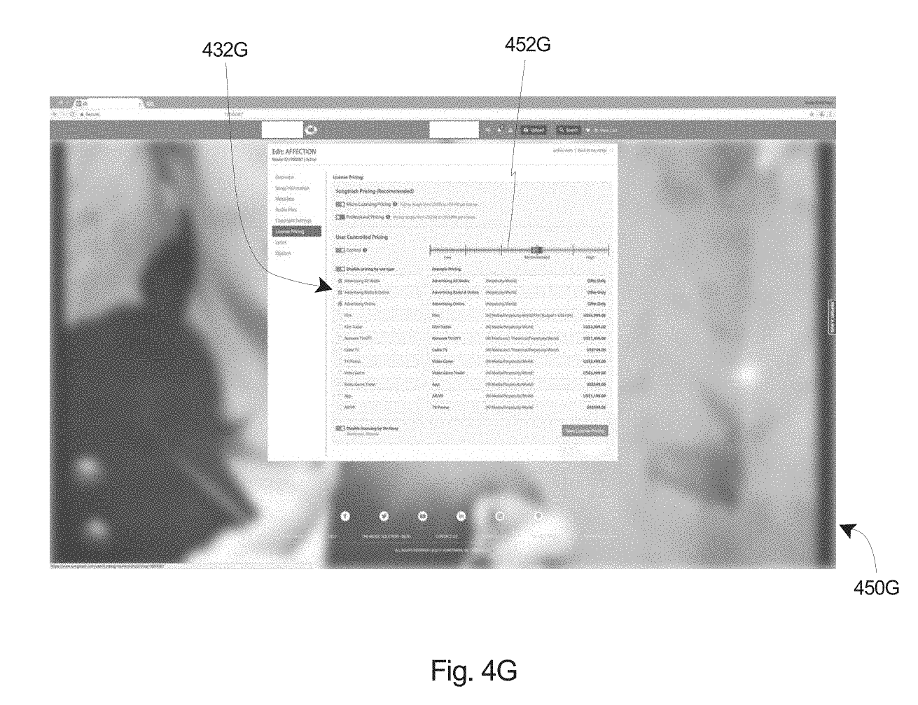

FIG. 4A is a simplified flowchart illustrating a representative example of the use of the seller zone 20 (illustrated in FIG. 1) of the intellectual property valuation system 10 (illustrated in FIG. 1) by a seller 14 (illustrated in FIG. 1) of intellectual property. Additionally, FIGS. 4B-4G are exemplar screen shots illustrating different portions of the seller zone 20 as the seller 14 works through the process of getting his or her intellectual property listed for licensing or sale within the valuation system 10.

Referring now to FIG. 4A, at step 401, the seller initially accesses the host device and the valuation system that is incorporated substantially within the host device. The seller then chooses to access and log into the seller zone within the host device.

At step 403, the seller establishes a personal or seller profile that is then saved within the valuation system, e.g., within the memory or one of the databases. In certain embodiments, the seller profile can include such information as the type of artist that the seller is, e.g., an instrumentalist, a songwriter, a vocalist (male or female), a group, a new artist, an established star, etc. Additionally, the seller profile can include a selection of the genre within which the seller typically performs. For example, for a musician or singer, the list of potential genres can include R&B/soul, indie rock, pop, hip hop, singer/songwriter, electronic, rock, country/blues, classical, jazz, new age/ambient, world, etc. It is understood that that the particular personal profile that is established by the seller can be seen as a seller-controlled pricing parameter that is incorporated into the valuation of the intellectual property. For example, it is appreciated that the pricing of intellectual property for an established star is likely to be somewhat higher than the pricing of intellectual property for a new artist. Additionally, certain genres may be more popular than others and, thus, likely warranting higher associated pricing.

At step 405, the seller uploads any selected items of intellectual property that the seller would like to have offered for licensing or sale within the valuation system. As noted above, any of the selected items of intellectual property can be offered for licensing or sale independently or as part of a group or catalog of items.

FIG. 4B is an exemplar screen shot 450B of a portion of the seller zone. In particular, FIG. 4B is an exemplar screen shot 450B of a web page through which the seller can upload their selected intellectual property onto the host device and the valuation system.

FIG. 4C is an exemplar screen shot 450C showing a full listing of the catalog of intellectual property (e.g., songs) that the seller has uploaded onto the host device. The seller can then manage their catalog of intellectual property in any suitable manner. For example, the seller can group any individual songs together so that they can be offered together for licensing or sales. Additionally or alternatively, the seller can dictate that all songs are only offered for licensing or sale on an individual basis.

At step 407, the seller is given the opportunity to edit and provide additional information related to any and all of their intellectual property that they have loaded onto the host device. More specifically, the seller can add any information that they believe is necessary for a full and complete understanding of any and all songs that they are listing for licensing or sale.

For example, the seller can edit any specific tracks where they believe certain changes may be warranted.

Additionally, the seller can provide any specific information they believe is necessary for any of their songs listed on the hot device. FIG. 4D is an exemplar screen shot 450D that shows a form into which the seller can choose to enter any information about any particular songs.

Further, the seller can also provide any metadata deemed necessary for a proper identification of their intellectual property.

Additionally, the seller can add any additional nested audio files that are believed necessary for their intellectual property, e.g., their songs, to be heard and appreciated in the best manner possible.

Still further, the seller can provide any copyright information necessary to best be able to protect their intellectual property. FIG. 4E is an exemplar screen shot 450E illustrating a form into which any necessary copyright information or settings can be attached to the intellectual property.

Yet further, the seller can supplement their listing with the lyrics that are found in their songs. FIG. 4F is an exemplar screen shot 450F that shows a basic form where the seller is able to add the song lyrics to their listing.

At step 409, the seller can view any or all of the administration-set default pricing parameters that have been associated with their intellectual property.

At step 411, the seller can view a default pricing matrix that has been generated for the selected items of intellectual property based on the application of the default pricing parameters within the specially designed algorithm within the control system.

At step 413, the seller can make any desired changes to the default pricing parameters for purposes of adjusting the pricing of the intellectual property within the (default) pricing matrix. In particular, the seller can accept/confirm any of the previously viewed default pricing parameters, or the seller can make any changes to the default pricing parameters or add any new pricing parameters deemed necessary to provide the seller-controlled pricing parameters that best support their listing and/or will provide them with the best pricing opportunities.

FIG. 4G is an exemplar screen shot 450G illustrating an embodiment of the pricing matrix 432G that can be manipulated as desired. In particular, as shown in this embodiment, the seller is given the opportunity to selectively turn on and off any of the listed verticals (i.e. so that no listing is possible in certain verticals) and any of the listed territories (i.e. so that no listing is possible in the chosen territories). Further, the seller is also able to adjust the general and overall pricing strategy. As shown, the pricing strategy has been established along a pricing strategy slider 452G that can be moved anywhere along a continuum from low to high. The pricing strategy slider 452G may also have certain pre-established price points along the continuum. For example, in one non-exclusive alternative embodiment, the pricing strategy slider 252G can have pre-established price points at $5,000, $6,400, $8,000, $10,000, $20,000 and $100,000. Alternatively, the pricing strategy slider 452G can include other suitable pre-established price points.

It is appreciated that the setting of the pricing strategy along the pricing strategy slider 452G can be interrelated with any and all information that may have been provided above in the seller profile. For example, a new artist is more likely to move the slider toward the low end of the scale, which an established star would be more likely to move the slider toward the high end of the scale. Of course, it is fully understood that any artist/seller can move the pricing strategy slider 452G in any manner deemed suitable regardless of the information they may have provide within the seller profile.

Additionally, it is also appreciated that any such changes to the pricing strategy slider 452G will see immediate changes in the pricing output for the various verticals, territories, etc. listed as the now seller-controlled pricing parameters.

At step 415, the seller can view a seller-controlled pricing matrix that has been generated for the selected items of intellectual property based on the application of the seller-controlled pricing parameters within the specially designed algorithm within the control system.

At step 417, the seller can confirm the seller-controlled pricing parameters and have the selected items of intellectual property listed for licensing or sale within the valuation system.

FIG. 5A is a simplified flowchart illustrating a representative example of the use of the buyer zone 22 (illustrated in FIG. 1) of the intellectual property valuation system 10 (illustrated in FIG. 1) by a buyer 16 (illustrated in FIG. 1) of intellectual property. Additionally, FIGS. 5B-5F are exemplar screen shots illustrating different portions of the buyer zone 22 as the buyer 16 works through the process of purchasing a license, or purchasing outright, any selected intellectual property.

Referring now to FIG. 5A, at step 501, the buyer initially accesses the host device and the valuation system that is incorporated substantially within the host device. The buyer then chooses to access and log into the buyer zone within the host device.

At step 503, the buyer establishes a personal or buyer profile that is then saved within the valuation system, e.g., within the memory or one of the databases. In certain embodiments, the buyer profile can include such information, i.e. use parameters 536 (illustrated, for example, in FIG. 5B), as (i) the type of user or buyer (e.g., personal, business), (ii) the type of use (e.g., one-time, ongoing), (iii) the vertical(s) within which the intellectual property will be used, (iv) the term or length of time that the intellectual property will be used, (v) the media type(s) within which the intellectual property will be used, (vi) the territory or territories within which the intellectual property will be used, (vii) the type, category or genre of intellectual property (e.g., music) that is desired to be used by the buyer, and (viii) the price range within which the buyer is willing to pay (e.g., between a maximum and minimum value or below a maximum value). It is appreciated that not all use parameters 536 need to be input by the buyer at this point, but could rather be input or designated at a later point in time, e.g., after the buyer has seen a full list of available intellectual property 538 (illustrated in FIG. 5C).

FIG. 5B is an exemplar screen shot 550B of a portion of the buyer zone of the valuation system. In particular, FIG. 5B is an exemplar screen shot 550B of a web page that shows the buyer various categories, or use parameters 536, of intellectual property (e.g., music) from which the buyer can choose. For example, as shown, in certain non-exclusive embodiments, the buyer is able to choose from the general categories of “Popular”, “Themes”, “Genres” and “Media”. Additionally, in some such embodiments, these general categories can be further broken down into sub-categories. In some non-exclusive alternative embodiments, the categories can be broken down into sub-categories as follows:

“Popular” into “Artists”, “Songwriters”, “Composers”, “Catalogs”, “One of a Kind” and “Staff Picks”;

“Themes” into “Adventure”, “Romantic”, “Action”, “Horror”, “Fantasy”, “Drama”, “Comedy”, “Inspirational”, “Tension”, “Mystery”, “Anticipation” and “Elimination”;

“Genres” into “R&B/Soul”, “Indie Rock”, “Pop”, “Hip Hop”, “Singer/Songwriter”, “Electronic”, “Rock”, “Country/Blues”, “Classical”, “Jazz”, “New Age/Ambient” and “World”; and

“Media” into “Film”, “TV”, “Trailer”, “Advertising”, “Video Games”, “Publishers”, “Producers”, “Production Music”, “Labels”, “New Media”, “TV Promo” and “Corporate”.

At step 505, the buyer receives and reviews a list of available items of intellectual property 538 as provided by the host device that had been stored within the database. The list of available items of intellectual property 538 is based on the buyer use parameters 536 that have been input already by the buyer into the host device at step 503, as well as the seller-controlled pricing parameters that had been input by the seller.

FIG. 5C is an exemplar screen shot 550C showing a listing of available items of intellectual property 538 based on any use parameters 536 (illustrated in FIG. 5B) that the buyer has input to this point, and that are in accordance with any seller-controlled pricing parameters that were provided by the seller during the process of uploading and storing their intellectual property onto the host device.

At step 507, the buyer selects the item(s) of intellectual property that he or she is interested in further evaluating, e.g., listening to, and further provides any necessary use parameters 536 in order to see specific pricing for the selected intellectual property based on intended use.

FIG. 5D is an exemplar screen shot 550D showing general pricing possibilities depending on general use categories. For example, in certain non-exclusive embodiments, the buyer can choose between “Personal Use”, which typically entails a single use for an individual; “Business Use”, which typically entails a single use by a business or organization (and which can be further broken down based on business earnings); and “Premium Use”, which entails any other more detailed or involved usages for the chosen intellectual property. It is appreciated that the choice among “Personal Use”, “Business Use” and “Premium Use” would also be considered one of the use parameters 536 as provided by the buyer in order to receive specific pricing alternatives.

FIG. 5E is an exemplar screen shot 550E wherein certain aspects, or use parameters 536, associated with a “Premium Use” can be further delineated for purposes of receiving specific pricing for the selected intellectual property.

At step 509, the buyer makes specific choices about what item(s) of intellectual property he or she would like to license or purchase.

At step 511, the buyer proceeds to checkout and is then able to use the purchased intellectual property in accordance with the identified use parameters.

FIG. 5F is an exemplar screen shot 550F illustrating an embodiment of the checkout process that can be experienced by the buyer when he or she finalizes the licensing or purchase of selected intellectual property.

It is appreciated that in the preceding examples, the numerous steps illustrated in the flowcharts shown in FIG. 4A and FIG. 5A can be altered from what is specifically shown without deviating from the intended scope and breadth of the present invention. In particular, it is understood that the order of the steps can be changed, certain steps can be combined, steps can be omitted, and additional steps can be added within the teachings of the present invention. Thus, the specific recitation and order of the steps as shown in these flowcharts is not intended to be limiting in any manner excepted as stated otherwise.

Additionally, it is further appreciated that any specific examples of pricing parameters, i.e. default pricing parameters 234A and/or seller-controlled pricing parameters 234B, and use parameters 536, are not intended to be limiting in any manner. Stated in another manner, the pricing parameters 234A, 234B can be any suitable or desired pricing parameters, and the use parameters 536 can be any suitable or desired use parameters, without deviating from the intended scope and breadth of the present invention.

It is understood that although a number of different embodiments of the intellectual property valuation system 10 have been illustrated and described herein, one or more features of any one embodiment can be combined with one or more features of one or more of the other embodiments, provided that such combination satisfies the intent of the present invention.

While a number of exemplary aspects and embodiments of the intellectual property valuation system 10 have been shown and disclosed herein above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope, and no limitations are intended to the details of construction or design herein shown.

What is claimed is:

1. An intellectual property valuation system for use by a seller to generate an automated price for licensing or sale of an item of intellectual property, the intellectual property valuation system comprising:
a host device including (i) a seller zone that is selectively accessible by the seller, and (ii) a control system including a processor that generates the seller zone;
at least one seller-controlled pricing parameter that is related to the item of intellectual property and that is inputted into the seller zone, the control system receiving the at least one seller-controlled pricing parameter from the seller zone and generating a seller-controlled pricing matrix for the item of intellectual property that is based at least in part on the at least one seller-controlled pricing parameter; and
a database that communicates with the control system, the seller-controlled pricing matrix being transmitted to and stored within the database.

2. The intellectual property valuation system of claim 1 wherein the at least one seller-controlled pricing parameter includes a vertical within which the item of intellectual property can be used.

3. The intellectual property valuation system of claim 1 wherein the at least one seller-controlled pricing parameter includes a territory within which the item of intellectual property can be used.

4. The intellectual property valuation system of claim 1 wherein the at least one seller-controlled pricing parameter includes a pricing strategy that sets a base price for the item of intellectual property.

5. The intellectual property valuation system of claim 1 further comprising a plurality of seller-controlled pricing parameters that are related to the item of intellectual property and that are inputted into the seller zone, the control system receiving the plurality of seller-controlled pricing parameters from the seller zone and generating the seller-controlled pricing matrix for the item of intellectual property that is based at least in part on each of the plurality of seller-controlled pricing parameters.

6. The intellectual property valuation system of claim 5 wherein the seller-controlled pricing matrix includes a separate automated price for the item of intellectual property for each of the plurality of seller-controlled pricing parameters.

7. The intellectual property valuation system of claim 6 further including a plurality of multipliers, wherein each multiplier is individually applied to one of the plurality of seller-controlled pricing parameters to independently adjust the separate automated price for the item of intellectual property for each of the plurality of seller-controlled pricing parameters.

8. The intellectual property valuation system of claim 5 wherein the plurality of seller-controlled pricing parameters includes a plurality of verticals that can be turned on or off independently from one another.

9. The intellectual property valuation system of claim 5 wherein the plurality of seller-controlled pricing parameters includes a plurality of territories that can be turned on or off independently from one another.

10. The intellectual property valuation system of claim 1 wherein the host device further includes an administration zone that is generated by the control system, the administration zone providing at least one default pricing parameter to the control system; and wherein the at least one seller-controlled pricing parameter is related to the at least one default pricing parameter.

11. The intellectual property valuation system of claim 1 wherein the database is an internal database that is positioned within the host device.

12. The intellectual property valuation system of claim 1 wherein the database is an external database that is positioned remotely from the host device.

13. The intellectual property valuation system of claim 1 wherein the host device further includes a buyer zone that is generated by the control system, the buyer zone being selectively accessible to a buyer; and wherein at least a portion of the seller-controlled pricing matrix is made available to the buyer based on at least one use parameter that is inputted into the buyer zone.

14. A method for generating an automated price for licensing or sale of an item of intellectual property, the method comprising the steps of:
uploading an item of intellectual property into a seller zone;
inputting at least one seller-controlled pricing parameter that is related to the item of intellectual property into the seller zone;
receiving the at least one seller-controlled pricing parameter with a control system that generates the seller zone;
generating a seller-controlled pricing matrix for the item of intellectual property with the control system, the seller-controlled pricing matrix being based at least in part on the at least one seller-controlled pricing parameter; and
transmitting the seller-controlled pricing matrix to a database so that the seller-controlled pricing matrix can be stored within the database.

15. The method of claim 14 wherein the step of inputting includes inputting a plurality of seller-controlled pricing parameters that are related to the item of intellectual property into the seller zone; wherein the step of receiving includes receiving the plurality of seller-controlled pricing parameters from the seller zone with the control system; and wherein the step of generating includes generating the seller-controlled pricing matrix for the item of intellectual property with the control system, the seller-controlled pricing matrix being based at least in part on each of the plurality of seller-controlled pricing parameters.

16. The method of claim 15 wherein the step of generating includes the seller-controlled pricing matrix including a separate automated price for the item of intellectual property for each of the plurality of seller-controlled pricing parameters.

17. The method of claim 16 further including the step of individually applying each of a plurality of multipliers to one of the plurality of seller-controlled pricing parameters to independently adjust the separate automated price for the item of intellectual property for each of the plurality of seller-controlled pricing parameters.

18. The method of claim 15 wherein the step of inputting includes moving a pricing strategy slider along a continuum to provide a base price for the item of intellectual property.

19. The method of claim 14 further including the step of providing at least one default pricing parameter to the control system; and wherein the step of inputting includes the at least one seller-controlled pricing parameter being related to the at least one default pricing parameter.

20. The method of claim 14 further comprising the steps of inputting at least one use parameter into a buyer zone that is generated by the control system; and making at least a portion of the seller-controlled pricing matrix available to a buyer based on the at least one use parameter.
